(19) United States
(12) Patent Application Publication
(10) Pub. No.: US 2015/0120564 A1
(43) Pub. Date: Apr. 30, 2015

(54) CHECK MEMO LINE DATA LIFT

(71) Applicant: BANK OF AMERICA CORPORATION, Charlotte, NC (US)

(72) Inventors: Michael Gerald Smith, Fort Mill, SC (US); Scott Andrew Johnson, Atlanta, GA (US); Michael Scott Hjellming, Cherryville, NC (US); Brian David Hanson, Charlotte, NC (US); Saravana Kumar Govindarajan, Atlanta, GA (US); Hyunmo Koo, Atlanta, GA (US)

(73) Assignee: BANK OF AMERICA CORPORATION, Charlotte, NC (US)

(21) Appl. No.: 14/066,109

(22) Filed: Oct. 29, 2013

(51) Int. Cl. G06Q 20/04

(52) U.S. Cl. CPC G06Q 20/042
USPC 705/45

(57) ABSTRACT

Disclosed is a system and associated method for categorizing a transaction performed using a negotiable instrument. The system is typically configured for receiving an indication of the transaction performed using the negotiable instrument, including receiving an image of the negotiable instrument; extracting transaction data from the image of the negotiable instrument, including extracting memo data from the image of the negotiable instrument; based at least in part on the extracted memo data, determining if the transaction is associated with a first predefined transaction category; and presenting at least a portion of the transaction data extracted from the image of the negotiable instrument to the customer, wherein, if the transaction is associated with the first predefined transaction category, presenting at least a portion of the extracted transaction data to the customer includes presenting an indication that the first predefined transaction category is associated with the transaction.

### FIELD OF THE INVENTION

The present invention embraces a system for categorizing a transaction performed using a negotiable instrument associated with a customer's account. The system typically includes a processor, a memory, and a categorization module that is stored in the memory and executable by the processor. The categorization module is typically configured for extracting memo data from an image of the negotiable instrument and determining a transaction category for the transaction based on the extracted memo data.

### BACKGROUND

Many financial institutions maintain image file records of all deposited checks and other negotiable instruments. Such check images may include various types of information. Accordingly, a need exists for improved systems and methods for extracting and using information found on check images.

### SUMMARY

In one aspect, the present invention embraces a method for categorizing a transaction performed using a negotiable instrument associated with a customer's account. The present invention also embraces a system configured for performing one or more of the steps of the method.

Typically, the system includes a computer apparatus including a processor and a memory and a categorization module that is stored in the memory and executable by the processor. The categorization module is typically configured for: receiving an indication of the transaction performed using the negotiable instrument, wherein receiving the indication of the transaction includes receiving an image of the negotiable instrument; extracting transaction data from the image of the negotiable instrument, wherein extracting transaction data includes extracting memo data from the image of the negotiable instrument; based at least in part on the extracted memo data, determining if the transaction is associated with a first predefined transaction category; and presenting at least a portion of the transaction data extracted from the image of the negotiable instrument to the customer, wherein, if the transaction is associated with the first predefined transaction category, presenting at least a portion of the transaction data extracted from the image of the negotiable instrument to the customer includes presenting an indication that the first predefined transaction category is associated with the transaction.

In one embodiment, the categorization module is configured for: presenting the extracted memo data and an indication that that the transaction could not be categorized to the customer; and receiving an indication from the customer that the transaction is associated with the first predefined transaction category. In a particular embodiment, presenting the extracted memo data to the customer includes presenting at least a portion of the image of the negotiable instrument to the customer, the portion of the image of the negotiable instrument being associated with the extracted memo data.

In another embodiment, the categorization module is configured for determining that the transaction is associated with the first predefined transaction category and with a second predefined transaction category. In a particular embodiment, extracting transaction data includes extracting a transaction amount from the image of the negotiable instrument; determining that the transaction is associated with the first predefined transaction category and with the second predefined transaction category includes determining that a first portion of the transaction amount is associated with the first predefined transaction category and that a second portion of the transaction amount is associated with the second predefined transaction category; and presenting at least a portion of the transaction data extracted from the image of the negotiable instrument to the customer includes presenting an indication that the first portion of the transaction amount is associated with the first predefined transaction category and that the second portion of the transaction amount is associated with the second predefined transaction category.

In yet another embodiment, extracting transaction data includes extracting payee information from the image of the negotiable instrument; and determining if the transaction is associated with the first predefined transaction category is based at least in part on the payee information extracted from the image of the negotiable instrument.

In yet another embodiment, the predefined transaction category is predefined by the customer.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 is a flowchart illustrating a system and method for identifying and extracting check data in accordance with various embodiments;

FIG. 2 provides a block diagram illustrating a system and environment for extracting and identifying check data in accordance with various embodiments;

FIG. 3 illustrates an exemplary image of a financial record in accordance with various embodiments;

FIG. 4 illustrates an exemplary template of a financial record in accordance with various embodiments; and

FIG. 5 is a flowchart illustrating a method for categorizing a transaction performed using a negotiable instrument.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In some embodiments, an “entity” as used herein may be a financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, a non-monetary user profile that includes only personal information associated with the user, or the like. The account is associated with and/or maintained by an entity. In other embodiments, an “entity” may not be a financial institution. In this regard, other businesses can take the place of or work in conjunction with the financial institution to perform one or more of the processes or steps described herein as being performed by a financial institution. Still in other embodiments of the invention the financial institution described herein may be replaced with other types of businesses that offer payment account systems to customers.

As used herein, an “online banking account” is an account that is associated with one or more user accounts at a financial institution. For example, the user may have an online banking account that is associated with the user's checking account, savings account, investment account, and credit account at a particular financial institution (e.g., the financial institution providing the online banking account). In some embodiments, the user's online banking account at a particular financial institution may also provide the user with access and information regarding user accounts that are maintained other financial institutions. For example, the user may provide a first financial institution with login information associated with the user's online banking account at a second financial institution. Accordingly, the user may be able to access the online banking account. A username and password are typically associated with the online banking account and can be used by the user to gain access to the online banking account. The online banking account may be accessed by the user over a network (e.g., the Internet) via a computer device, such as a personal computer, laptop, or mobile device (e.g., a smartphone or tablet). The online banking account may be accessed by the user via a mobile or online banking website or via a mobile or online banking application. A customer may access an online banking account to view account balances, view transaction history, view statements, transfer funds, and pay bills. More than one user may have access to the same online banking account. In this regard, each user may have a different username and password. Accordingly, one or more users may have a sub-account associated with the online banking account.

In some embodiments, the “user” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded). In other embodiments, the “customer” may refer to the user.

The embodiments described herein may refer to the use of a transaction, transaction event or point of transaction event to trigger the steps, functions, routines, or the like described herein. In various embodiments, occurrence of a transaction triggers the sending of information such as offers and the like. Unless specifically limited by the context, a “transaction”, “transaction event” or “point of transaction event” refers to any communication between the customer and the merchant, financial institution, or other entity monitoring the customer's activities. In some embodiments, for example, a transaction may refer to a purchase of goods or services, a return of goods or services, a payment transaction, a credit transaction, or other interaction involving a customer's bank account. As used herein, a “bank account” refers to a credit account, a debit/deposit account, or the like. Although the phrase “bank account” includes the term “bank,” the account need not be maintained by a bank and may, instead, be maintained by other financial institutions. For example, in the context of a financial institution, a transaction may refer to one or more of a sale of goods and/or services, an account balance inquiry, a rewards transfer, an account money transfer, opening a bank application on a customer's computer or mobile device, a customer accessing their e-wallet or any other interaction involving the customer and/or the customer's device that is detectable by the financial institution. As further examples, a transaction may occur when an entity associated with the customer is alerted via the transaction of the customer's location. A transaction may occur when a customer accesses a building, uses a rewards card, and/or performs an account balance query. A transaction may occur as a customer's mobile device establishes a wireless connection, such as a Wi-Fi connection, with a point-of-sale (or point-of-transaction) terminal. In some embodiments, a transaction may include one or more of the following: purchasing, renting, selling, and/or leasing goods and/or services (e.g., groceries, stamps, tickets, DVDs, vending machine items, and the like); withdrawing cash; making payments to creditors (e.g., paying monthly bills; paying federal, state, and/or local taxes and/or bills; or the like); sending remittances; transferring balances from one account to another account; loading money onto stored value cards (SVCs) and/or prepaid cards; donating to charities; and/or the like.

In some embodiments, the transaction may refer to an event and/or action or group of actions facilitated or performed by a customer's device, such as a customer's mobile device. Such a device may be referred to herein as a “point-of-transaction device”. A “point-of-transaction” could refer to any location, virtual location or otherwise proximate occurrence of a transaction. A “point-of-transaction device” may refer to any device used to perform a transaction, either from the customer's perspective, the merchant's perspective or both. In some embodiments, the point-of-transaction device refers only to a customer's device, in other embodiments it refers only to a merchant device, and in yet other embodiments, it refers to both a customer device and a merchant device interacting to perform a transaction. For example, in one embodiment, the point-of-transaction device refers to the customer's mobile device configured to communicate with a merchant's point of sale terminal, whereas in other embodiments, the point-of-transaction device refers to the merchant's point of sale terminal configured to communicate with a customer's mobile device, and in yet other embodiments, the point-of-transaction device refers to both the customer's mobile device and the merchant's point of sale terminal configured to communicate with each other to carry out a transaction.

In some embodiments, a point-of-transaction device is or includes an interactive computer terminal that is configured to initiate, perform, complete, and/or facilitate one or more transactions. A point-of-transaction device could be or include any device that a customer may use to perform a transaction with an entity, such as, but not limited to, an ATM, a loyalty device such as a rewards card, loyalty card or other loyalty device, a magnetic-based payment device (e.g., a credit card, debit card, or the like), a personal identification number (PIN) payment device, a contactless payment device (e.g., a key fob), a radio frequency identification device (RFID) and the like, a computer, (e.g., a personal computer, tablet computer, desktop computer, server, laptop, or the like), a mobile device (e.g., a smartphone, cellular phone, personal digital assistant (PDA) device, MP3 device, personal GPS device, or the like), a merchant terminal, a self-service machine (e.g., vending machine, self-checkout machine, or the like), a public and/or business kiosk (e.g., an Internet kiosk, ticketing kiosk, bill pay kiosk, or the like), a gaming device, and/or various combinations of the foregoing.

In some embodiments, a point-of-transaction device is operated in a public place (e.g., on a street corner, at the doorstep of a private residence, in an open market, at a public rest stop, or the like). In other embodiments, the point-of-transaction device is additionally or alternatively operated in a place of business (e.g., in a retail store, post office, banking center, grocery store, factory floor, or the like). In accordance with some embodiments, the point-of-transaction device is not owned by the customer of the point-of-transaction device. Rather, in some embodiments, the point-of-transaction device is owned by a mobile business operator or a point-of-transaction operator (e.g., merchant, vendor, salesperson, or the like). In yet other embodiments, the point-of-transaction device is owned by the financial institution offering the point-of-transaction device providing functionality in accordance with embodiments of the invention described herein.

As presented herein, embodiments that detect and extract specific data from images and that analyze, process, and distribute extracted metadata are provided. As used herein, the term “financial record” refers to, but is not limited to records associated with financial data, account data, government data, legal data, identification data, and the like. Exemplary financial records include legal documents, wills, court papers, legal memorandum, leases, birth certificates, negotiable instruments (e.g., checks), receipts, contracts, loan documents, financial statements, bills, and combinations thereof. Although the disclosure is directed to financial records, it will be understood that non-financial records such as social communications, advertising, blogs, opinion writing, and the like may also be applicable to the disclosure presented herein. In cases were non-financial records are used, it will be understood that personal information, such personal identifying information, account numbers, and the like, can be removed from the documents before they are released. For example, if a coupon or product review is to be used in advertising, personal information associated with such records will be removed before the advertising is presented to the public. The data of the financial records or non-financial records may be provided in a wide variety formats including, paper records, electronic or digital records, video records, audio records, and/or combinations thereof.

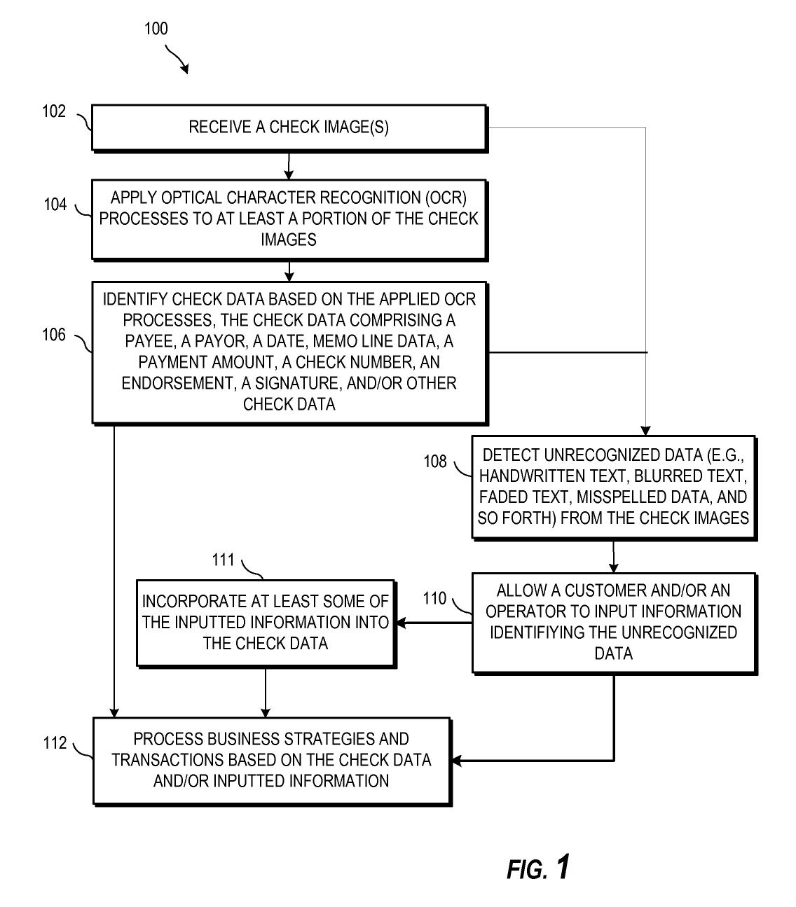

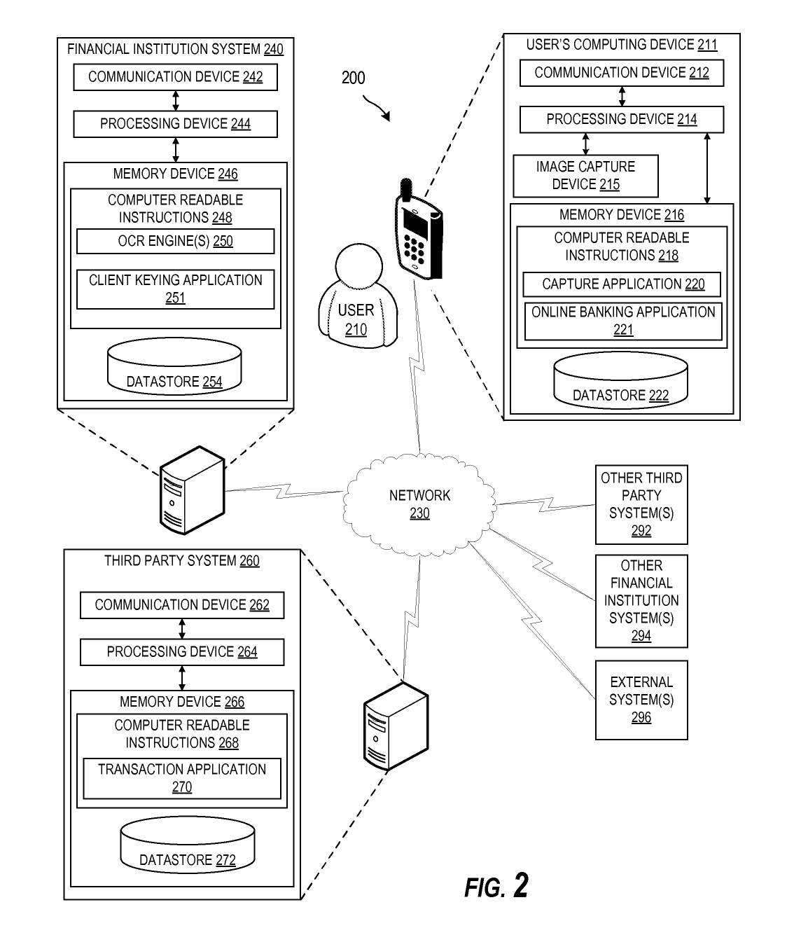

Referring now to the figures, FIG. 1 provides a flowchart illustrating a process 100 for identifying and extracting data from check images or images of other negotiable instruments. One or more devices, such as the one or more systems and/or one or more computing devices and/or servers of FIG. 2, can be configured to perform one or more steps of the process 100 or other processes described below. In some embodiments, the one or more devices performing the steps are associated with a financial institution. In other embodiments, the one or more devices performing the steps are associated with a merchant, business, partner, third party, credit agency, account holder, and/or user.

As illustrated at block 102, one or more check images are received. The check images typically include the front portion of a check, the back portion of a check, or any other portions of a check. In cases where there are several checks piled into a stack, the multiple check images may include, for example, at least a portion of each of the four sides of the check stack. In this way, any text, numbers, or other data provided on any side of the check stack may also be used in implementing the process 100. Although check images are described in FIG. 1, it will be understood that any type of financial record image or non-financial record image may be included in process 100.

In some embodiments, each of the check images includes financial record data (e.g., transaction data). The financial record data may include dates financial records are issued, terms of the financial record, time period that the financial record is in effect, identification of parties associated with the financial record, payee information, payor information, obligations of parties to a contract, purchase amount, loan amount, consideration for a contract, representations and warranties, product return policies, product descriptions, check numbers, document identifiers, account numbers, merchant codes, file identifiers, source identifiers, other transaction information, and the like. In some embodiments, the check images include markings. The markings may include, for example, text, numbers, symbols, other characters, lines, shadows, shapes, ink blots, stains, logos, paper tears, smudges, watermarks, any visible marking on the paper check, any visible marking applied electronically to the check image, or any pixel/texel quantity thereof.

Although check images are illustrated in FIG. 1, it will be understood that any type of financial record image may be received in accordance with the embodiments of FIG. 1. Exemplary check images include PDF files, scanned documents, digital photographs, and the like. At least a portion of each of the check images, in some embodiments, is received from a financial institution, a merchant, a signatory of the financial record (e.g., the entity having authority to endorse or issue a financial record), and/or a party to a financial record. In other embodiments, the check images are received from image owners, account holders, agents of account holders, joint account holders, family members of account holders, financial institution customers, payors, payees, third parties, and the like. In some embodiments, the source of at least one of the checks includes an authorized source such as an account holder or a third party financial institution. In other embodiments, the source of at least one of the checks includes an unauthorized source such as an entity that intentionally or unintentionally deposits or provides a check image to the system of process 100.

In some exemplary embodiments, a customer or other entity takes a picture of a check at a point of sales or an automated teller machine (ATM) and communicates the resulting check image to a point-of-transaction device or point-of-sale device or ATM via wireless technologies, near field communication (NFC), radio frequency identification (RFID), and other technologies. In other examples, the customer uploads or otherwise sends the check image to the system of process 100 via email, short messaging service (SMS) text, a web portal, online account, mobile applications, and the like. For example, the customer may upload a check image to deposit funds into an account or pay a bill via a mobile banking application using a capture device. In other embodiments, a financial institution may receive the actual check from the customer or other entity and then create an image of the check using a capture device. The capture device can include any type or number of devices for capturing images or converting a check to any type of electronic format such as a camera, personal computer, laptop, notebook, scanner, mobile device, and/or other device.

As illustrated at block 104, optical character recognition (OCR) processes are applied to at least a portion of the check images. At least one OCR process may be applied to each of the check images or some of the check images. The OCR processes enables the system to convert handwritten or printed text and other symbols in the check images to other formats such as text files and/or metadata, which can then be used and incorporated into a variety of applications, documents, and processes. In some embodiments, OCR based algorithms used in the OCR processes incorporate pattern matching techniques. For example, each character in an imaged word, phrase, code, or string of alphanumeric text can be evaluated on a pixel-by-pixel basis and matched to a stored character. Various algorithms may be repeatedly applied to determine the best match between the image and stored characters. In some embodiments, other processing techniques such as intelligent word recognition (IWR) and intelligent character recognition (ICR) may be used to recognize and extract handwritten text.

In some embodiments, the OCR process includes location fields for determining the position of data on the check image. Based on the position of the data, the system can identify the type of data in the location fields to aid in character recognition. For example, an OCR engine may determine that text identified in the upper right portion of a check image corresponds to a check number. The location fields can be defined using any number of techniques. In some embodiments, the location fields are defined using heuristics. The heuristics may be embodied in rules that are applied by the system for determining approximate location.

In other embodiments, the system executing process flow 100 defines the location fields by separating the portions and/or elements of the image of the check into quadrants. As referred to herein, the term quadrant is used broadly to describe the process of differentiating elements of a check image by separating portions and/or elements of the image of the check into sectors in order to define the location fields. These sectors may be identified using a two-dimensional coordinate system or any other system that can be used for determining the location of the sectors. In many instances, each sector will be rectangular in shape. In some embodiments, the system identifies each portion of the image of the check using a plurality of quadrants. In such an embodiment, the system may further analyze each quadrant using the OCR algorithms in order to determine whether each quadrant has valuable or useful information. Generally, valuable or useful information may relate to any data or information that may be used for processing and/or settlement of the check, used for identifying the check, and the like. Once the system determines the quadrants of the image of the check having valuable and/or useful information, the system can extract the identified quadrants together with the information from the image of the check for storage. The quadrants may be extracted as metadata, text, or code representing the contents of the quadrant. In some embodiments, the quadrants of the image of the check that are not identified as having valuable and/or useful information are not extracted from the image.

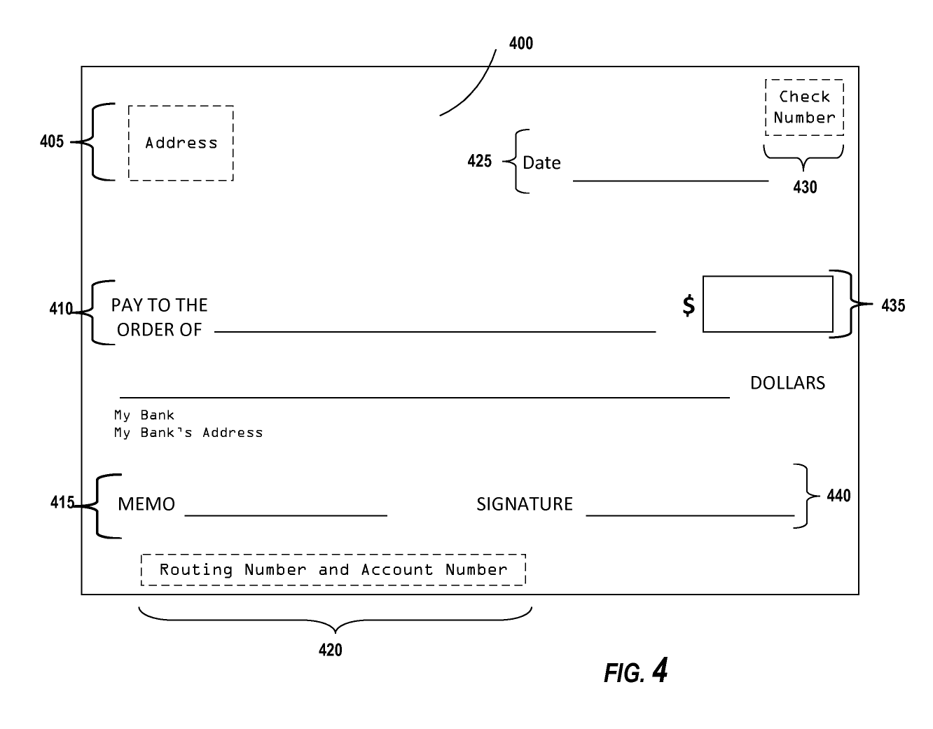

In additional embodiments, the system uses a grid system to identify non-data and data elements of a check image. The grid system may be similar to the quadrant system. Using the grid system, the system identifies the position of each grid element using a coordinate system (e.g., x and y coordinates or x, y, and z coordinate system or the like) or similar system for identifying the spatial location of a grid element on a check. In practice, the spatial location of a grid element may be appended to or some manner related to grid elements with check data. For example, using the grid, the system may identify which grid elements of the grid contain data elements, such as check amount and payee name, and either at the time of image capture or extraction of the check image within the grid, the system can tag the grid element having the check data element with the grid element's spatial location. In some embodiments, the grid system and/or quadrant system is based on stock check templates obtained from check manufacturers or merchants (e.g., as depicted in FIG. 4).

In alternative or additional embodiments, the OCR process includes predefined fields to identify data. The predefined field includes one or more characters, words, or phrases that indicate a type of data. In such embodiments, the system of process 100 extracts all the data presented in the check image regardless of the location of the data and uses the predefined fields to aid in character recognition. For example, a predefined field containing the phrase “Pay to the order of” may be used to determine that data following the predefined field relates to payee information.

In addition to OCR processes, the system of process 100 can use other techniques such as image overlay to locate, identify, and extract data from the check images. In other embodiments, the system uses the magnetic ink character recognition (MICR) to determine the position of non-data (e.g., white space) and data elements on a check image. For example, the MICR of a check may indicate to the system that the received or captured check image is a business check with certain dimensions and also, detailing the location of data elements, such as the check amount box or Payee line. In such an instance, once the positions of this information is made available to the system, the system will know to capture any data elements to the right or to the left of the identified locations or include the identified data element in the capture. This system may choose to capture the data elements of a check in any manner using the information determined from the MICR number of the check.

As illustrated at block 106, check data is identified based on the applied OCR processes. In some embodiments, the check data includes a payee, a payor, a date, memo line data, a payment amount, a check number, and endorsement, a signature and/or other check data. The check data, in some embodiments, is identified based on the final objectives of the process 100. As discussed in more detail below, the final objectives of the process 100 can include a variety of business strategies and transactions. In other embodiments, the system of process 100 identifies all recognizable text and markings in the check images. In such cases, the system may further narrow or expand the identified check data as needed.

As illustrated at block 108, unrecognized data from the check images is detected. In some embodiments, the unrecognized data includes characters, text, shading, or any other data not identified by the OCR processes. In such embodiments, the unrecognized data is detected following implementation of at least one of the OCR processes. In other embodiments, the unrecognized data is detected prior to application of the OCR processes. For example, the unrecognized data may be removed and separated from the check images or otherwise not subjected to the OCR processes. In one exemplary situation, the system may determine that handwritten portions of a check image should not undergo OCR processing due to the difficulty in identifying such handwritten portions. Exemplary unrecognized data includes handwritten text, blurred text, faded text, misaligned text, misspelled data, any data not recognized by the OCR processes or other data recognition techniques, and the like. In other cases, at least a portion of some or all of the check images may undergo pre-processing to enhance or correct the unrecognized data. For example, if the text of a check image is misaligned or blurry, the system may correct that portion of the check image before applying the OCR processes to increase the probability of successful text recognition in the OCR processes or other image processes.

As illustrated at block 110, inputted information identifying the unrecognized data from a customer and/or an operator is received. In some embodiments, an operator is provided with the portions of a check image corresponding to the unrecognized data. The operator can view the unrecognized data to translate the unrecognized data into text and input the translation into a check data repository. In this way, the system “learns” to recognize previously unrecognized data such that when the system reviews the same or similar unrecognized data in the future, such data can be easily identified by reference to the check data repository. In other embodiments, the system may present an online banking customer with the unrecognized data (e.g., an image of at least the portion of a check containing unrecognized data) to solicit input directly from the customer. For example, the customer may be presented with operator-defined terms of previously unrecognized data to verify if such terms are correct. The system may solicit corrective input from the customer via an online banking portal, a mobile banking application, and the like. If an operator initially determines that the handwriting on the memo line reads “house flaps,” the customer may subsequently correct the operator's definition and update the check data repository so that the handwritten portion correctly corresponds to “mouse traps.” In some embodiments, the customer's input is stored in a customer input repository, which is linked to the check data repository associated with the OCR processes. For example, the system can create a file path linking the customer input repository with the check data repository to automatically update the check data repository with the customer input. In other embodiments, the check data repository and/or customer input repository includes stored customer data or account data. Stored customer signatures, for example, may be included in the check data repository and/or customer input repository. As illustrated at block 111, at least some of the inputted information is incorporated in the check data. In cases where the OCR processes utilizes a repository that includes manual input such as a check data repository or customer input repository, previously unrecognized data can be matched to definitions submitted by the operator and/or customer.

As illustrated at block 112, business strategies and transactions are processed based on at least one of the check data and the inputted information. Metadata extracted from the check images using the process 100 may be used to automate or enhance various processes such as remediating exception processes, replacing check images with check data in online statements, enforcing requirements regarding third party check deposits, facilitating check to automated clearing house transaction conversion, cross selling products, and so forth.

Referring now to FIG. 2, a block diagram illustrates an environment 200 for detecting and extracting check data. The environment 200 includes a computing device 211 (e.g., a laptop, personal computer, mobile device, smartphone, tablet computer, personal digital assistant, and the like) of a user 210 (e.g., an account holder, a mobile application user, an image owner, a bank customer, and the like), a third party system 260, and a financial institution system 240. In some embodiments, the third party system 260 corresponds to a third party financial institution. The environment 200 further includes one or more third party systems 292 (e.g., a partner, agent, or contractor associated with a financial institution), one or more other financial institution systems 294 (e.g., a credit bureau, third party banks, and so forth), and one or more external systems 296. The systems and devices communicate with one another over the network 230 and perform one or more of the various steps and/or methods according to embodiments of the disclosure discussed herein. The network 230 may include a local area network (LAN), a wide area network (WAN), and/or a global area network (GAN). The network 230 may provide for wireline, wireless, or a combination of wireline and wireless communication between devices in the network. In one embodiment, the network 230 includes the Internet.

The computing device 211, the third party system 260, and the financial institution system 240 each includes a computer system, server, multiple computer systems and/or servers or the like. The financial institution system 240, in the embodiments shown has a communication device 242 communicably coupled with a processing device 244, which is also communicably coupled with a memory device 246. The processing device 244 is configured to control the communication device 242 such that the financial institution system 240 communicates across the network 230 with one or more other systems. The processing device 244 is also configured to access the memory device 246 in order to read the computer readable instructions 248, which in some embodiments includes a one or more OCR engine applications 250 and a client keying application 251. The memory device 246 also includes a datastore 254 or database for storing pieces of data that can be accessed by the processing device 244. In some embodiments, the datastore 254 includes a check data repository. The financial institution system 240 typically includes an online banking system that allows the customer to log into his/her account such that the customer can access data that is associated with the customer (e.g., the customer's online banking account). In this regard, the customer can use the computing device 211 to log into the online banking system to access the customer's online banking account. Logging into the online banking system generally requires that the customer authenticate his/her identity using a user name, a passcode, a cookie, a biometric identifier, a private key, a token, and/or another authentication mechanism that is provided by the customer to the online banking system via the computing device 211.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

The user's computing device 211 (e.g., a mobile device such as a smartphone, cellphone, or tablet computer) includes a communication device 212 and an image capture device 215 (e.g., a camera) communicably coupled with a processing device 214, which is also communicably coupled with a memory device 216. The processing device 214 is configured to control the communication device 212 such that the user's computing device 211 communicates across the network 230 with one or more other systems. The processing device 214 is also configured to access the memory device 216 in order to read the computer readable instructions 218, which in some embodiments includes a capture application 220 and an online banking application 221. In some embodiments, the online banking application 221 may be used to interact with the online banking system. In other embodiments, a web browser application stored on the computing device 211 may be used to interact with the online banking system. The memory device 216 also includes a datastore 222 or database for storing pieces of data that can be accessed by the processing device 214.

The third party system 260 includes a communication device 262 and an image capture device (not shown) communicably coupled with a processing device 264, which is also communicably coupled with a memory device 266. The processing device 264 is configured to control the communication device 262 such that the third party system 260 communicates across the network 230 with one or more other systems. The processing device 264 is also configured to access the memory device 266 in order to read the computer readable instructions 268, which in some embodiments includes a transaction application 270. The memory device 266 also includes a datastore 262 or database for storing pieces of data that can be accessed by the processing device 264.

In some embodiments, the capture application 220, the online banking application 221, and the transaction application 270 interact with the OCR engines 250 to receive or provide financial record images and data, detect and extract financial record data from financial record images, analyze financial record data, and implement business strategies, transactions, and processes. The OCR engines 250, the client keying application 251, and the dictionary application 252 may be a suite of applications for conducting OCR or other techniques for extracting information from financial record images.

The applications 220, 221, 250, 251, 252, and 270 are for instructing the processing devices 214, 244 and 264 to perform various steps of the methods discussed herein, and/or other steps and/or similar steps. In various embodiments, one or more of the applications 220, 221, 250, 251, 252, and 270 are included in the computer readable instructions stored in a memory device of one or more systems or devices other than the systems 260 and 240 and the user's computing device 211. For example, in some embodiments, the application 220 is stored and configured for being accessed by a processing device of one or more third party systems 292 connected to the network 230. In various embodiments, the applications 220, 221, 250, 251, 252, and 270 stored and executed by different systems/devices are different. In some embodiments, the applications 220, 221, 250, 251, 252, and 270 stored and executed by different systems may be similar and may be configured to communicate with one another, and in some embodiments, the applications 220, 221, 250, 251, 252, and 270 may be considered to be working together as a singular application despite being stored and executed on different systems.

In various embodiments, one of the systems discussed above, such as the financial institution system 240, is more than one system and the various components of the system are not collocated, and in various embodiments, there are multiple components performing the functions indicated herein as a single device. For example, in one embodiment, multiple processing devices perform the functions of the processing device 244 of the financial institution system 240 described herein. In various embodiments, the financial institution system 240 includes one or more of the external systems 296 and/or any other system or component used in conjunction with or to perform any of the method steps discussed herein. For example, the financial institution system 240 may include a financial institution system, a credit agency system, and the like.

In various embodiments, the financial institution system 240, the third party system 260, and the user's computing device 211 and/or other systems may perform all or part of one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 300, the other methods discussed below, or other methods, processes or steps discussed herein or not discussed herein.

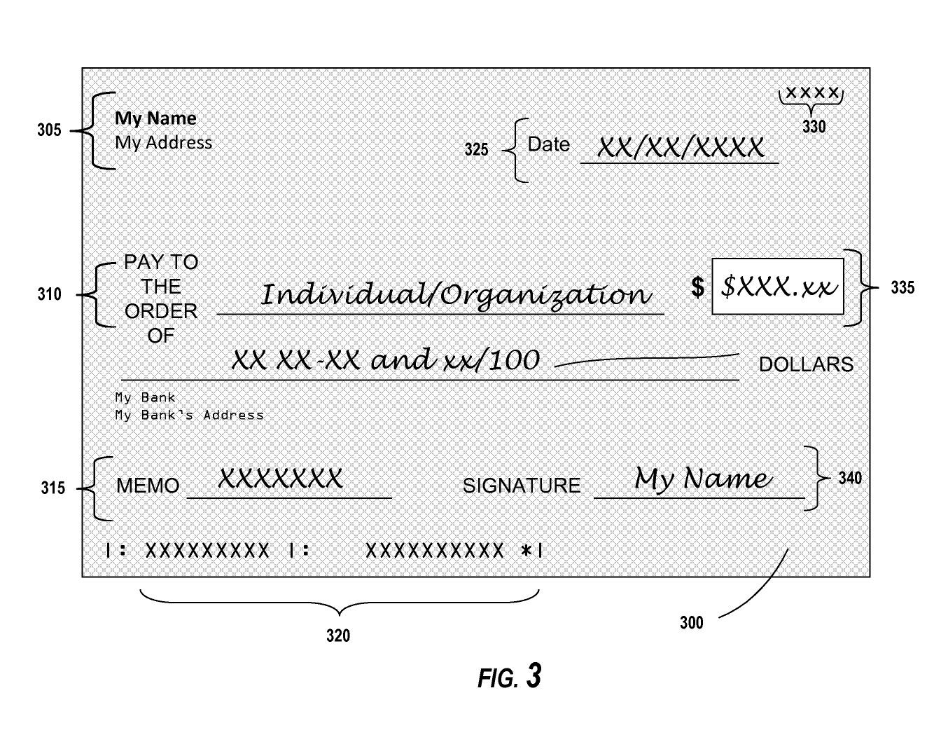

Referring now to FIG. 3, an exemplary image of a check 300 is illustrated. The image of check 300 may include an image of the entire check, a thumbnail version of the image of the check, individual pieces of check information, all or some portion of the front of the check, all or some portion of the back of the check, or the like. Check 300 includes check information, wherein the check information includes contact information 305, the payee 310, the memo description 315, the account number and routing number 320 associated with the appropriate user or customer account, the date 325, the check number 330, the amount of the check 335, the signature 340, or the like. In some embodiments, the check information may include text. In other embodiments, the check information may include an image. A capture device (e.g., the user's computing device 212 of FIG. 2) may capture an image of the check 300 and transmit the image to a system of a financial institution (e.g., the financial institution system 240 of FIG. 2) via a network. The system may extract the check information from the image of the check 300 and store the check information in a datastore as metadata (e.g., the datastore 254 of FIG. 2). In some embodiments, the pieces of check information may be stored in the datastore individually. In other embodiments, multiple pieces of check information may be stored in the datastore together.

Referring now to FIG. 4, a check template 400 illustrated. In the illustrated embodiment, the check template 400 corresponds to the entire front portion of a check, but it will be understood that the check template 400 may also correspond to individual pieces of check information, portions of a check, or the like. The check template, in some embodiments, includes the format of certain types of checks associated with a bank, a merchant, an account holder, types of checks, style of checks, check manufacturer, and so forth. By using the check template, the system of process 100 any other system can “learn” to map the key attributes of the check for faster and more accurate processing. In some embodiments, financial records are categorized by template. The check template 400 is only an exemplary template for a financial record, and other check templates or other financial record templates may be utilized to categorize checks or other financial records. The check template 400 can be used in the OCR processes, image overlay techniques, and the like.

The check template 400 includes check information, wherein the check information includes, for example, a contact information field 405, a payee line field 410, a memo description field 415, an account number and routing number field 420 associated with the appropriate user or customer account, a date line field 425, a check number field 430, an amount box field 435, a signature line field 440, or the like.

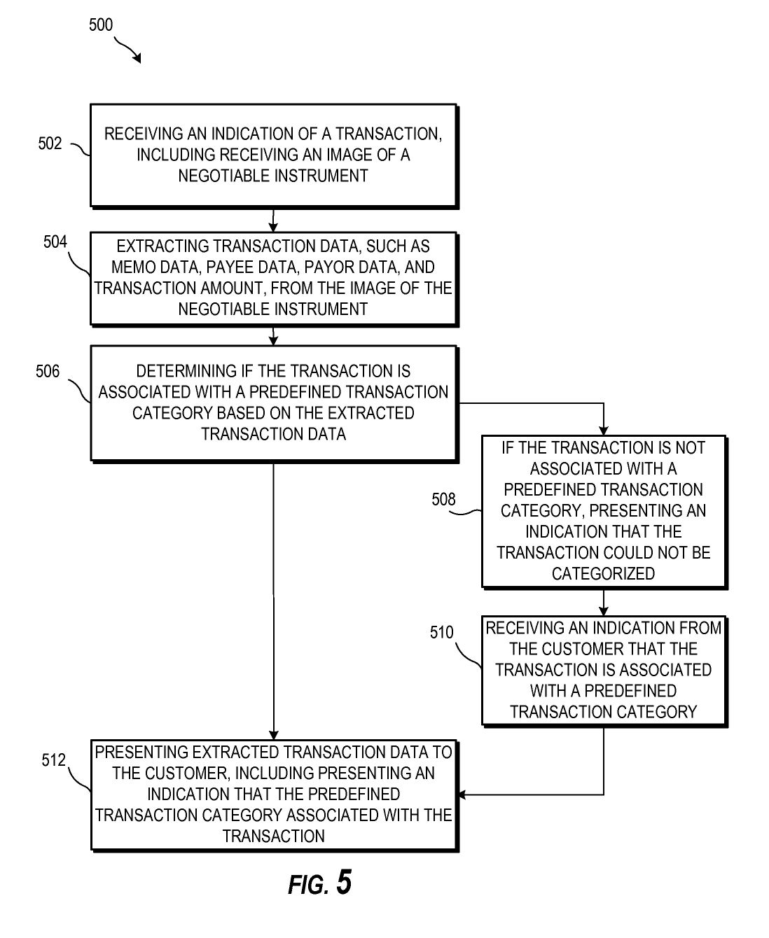

In a particular aspect, the present invention embraces a method for categorizing a transaction performed using a negotiable instrument. In this regard, FIG. 5 depicts an exemplary method 500 for categorizing a transaction performed using a negotiable instrument, which may be performed by the financial institution system 240 depicted in FIG. 2.

Initially, at block 502, the financial institution system 240 receives an indication of a transaction performed using a negotiable instrument (e.g., a check) associated with a customer's account (e.g., an account provided by a financial institution). The indication of the transaction typically includes an image of the negotiable instrument. By way of example, a merchant may transmit the indication of the transaction, including the image of the negotiable instrument, to the financial institution system 240 by using a point-of-transaction device. By way of further example, the merchant or other payee may deposit the negotiable instrument at an ATM, which may then transmit the indication of the transaction, including the image of the negotiable instrument, to the financial institution system 240.

Next, at block 504, the financial institution system 240 extracts transaction data, such as financial record data, from the image of the negotiable instrument (e.g., using OCR, IWR, ICR, and/or other processing techniques). Such extracted transaction data typically includes payee information, payor information, account number, transaction amount, and memo data. In one embodiment, memo data may be any information proximate to (e.g., in the vicinity of) the memo description field of a check. Thus, memo data is not limited to information directly above a check's memo line. Instead memo data may be any information above, below, adjacent to, or in the vicinity of the memo description field. In one embodiment, memo data may be any information located in a quadrant proximate to and including the memo description field. In other embodiments, memo data may be located in an alternative location on a check that is not proximate to the memo description field. For example, such an alternative location may include the ordinarily blank portion of the check above the payee line field or below the signature line field. Such an alternative location for memo data may be defined by the financial institution or by the customer.

At block 506, the financial institution system 240 employs the extracted memo data to determine if the transaction is associated with one or more predefined transaction categories and/or subcategories. In this regard, the financial institution system 240 may compare extracted memo data to key words and/or phrases associated with the predefined transaction categories. For example, if the extract memo data is the phrase “Happy birthday!” the financial institution system 240 may determine that this phrase is associated with a gifts transaction category.

Alternatively or in addition to extracted memo data, other types of extracted transaction data, such as the name of the payee or the date of the transaction, may be used to determine if the transaction is associated with one or more predefined transaction categories and/or subcategories. For example, if memo data cannot be extracted but payee information is successfully extracted and identifies the payee as a grocery store, the financial institution system 240 may determine that the transaction is associated with a groceries transaction category.

In a particular embodiment, the financial institution system 240 may determine that the transaction is associated with multiple predefined transaction categories. For example, if the memo data includes the terms “produce” and “medicine” and payee information identifies the payee as a grocery store, the financial institution system 240 may determine that the transaction is associated with a groceries transaction category and with a pharmacy transaction category. In a particular embodiment, the financial institution system 240 may associate a portion of an extracted transaction amount with each transaction category (e.g., by equally dividing the transaction amount among the identified transaction categories). Thus, in the immediately foregoing example, half of the transaction amount may be associated with the groceries transaction category and half of the transaction amount may be associated with the pharmacy transaction category. In a further particular embodiment, memo line data may indicate a percentage or particular amount of the transaction amount to attribute to each identified category. By way of example, if the memo data includes the phrases “produce 70%” and “medicine 30%,” the financial institution system 240 may associate seventy percent of the transaction amount with the groceries transaction category and thirty percent of the transaction amount with the pharmacy transaction category.

The transaction categories and subcategories may be defined by the financial institution and/or by the customer. For example, the financial institution may define a default set of categories, which the customer may then have the option of customizing by creating, deleting, and/or adjusting transaction categories. In some embodiments, the financial institution and/or the customer may define that particular key words or phrases are associated with a predefined category. Such key words or phrases may be used by the customer when writing a check (e.g., by including a key word or phrase in the check memo line) to ensure that the check is properly categorized.

Once a transaction has been categorized, the transaction category is then stored (e.g., in a datastore) along with other transaction data.

If the financial institution system 240 cannot determine a category for the transaction associated with the negotiable instrument (e.g., based on extracted transaction data), then, in block 508, the extracted transaction data, including the extracted memo data, is presented to the customer along with an indication that the transaction could not be categorized. In this regard, the financial institution system 240 might not be able to determine a category for the transaction because handwriting proximate to the memo description field and/or the payee field may be unreadable, blurred, faded, or misspelled. Alternatively, extracted memo data and/or payee information may not adequately correspond to any predefined transaction category.

The extracted transaction data and the indication that the transaction could not be categorized may be provided to the customer by the financial institution system 240 through an online banking website (e.g., a mobile banking website) that the customer accesses via a web browser on the computing device 211 or through an online banking application on the computing device 211. In this regard, the online banking website and/or online banking application may present a graphical user interface (GUI) that displays information regarding one or more transactions associated with the customer's online banking account, including extracted transaction data (e.g., payee, memo data, and transaction amount) and an indication that the transaction could not be categorized (e.g., a category field in the displayed transaction information may indicate that the transaction is “uncategorized”).

In some embodiments, presenting extracted memo data to the customer may include providing an image of the negotiable instrument to the customer. Alternatively, the portion of the image that includes memo data (e.g., unreadable or unidentifiable memo data) may be provided to the customer. For example, an image of the portion of the negotiable instrument corresponding to a memo description field quadrant may be provided to the customer.

Next, in block 510, the financial institution system 240 may receive an indication from the customer that the transaction is associated with one or more transaction categories. In this regard, the customer may use the online banking website or online banking application to interact with the financial institution system 240 and provide the transaction category that should be associated with the transaction. Once the transaction category has been provided by the customer, the transaction category is then stored (e.g., in a datastore) along with other transaction data.

Finally, in block 512, once a transaction category has been identified for the transaction (e.g., by analyzing extracted memo data or receiving the category from the customer), extracted transaction data as well as an indication of the transaction category may be presented to the customer (e.g., in response to a request from the customer to view transaction data). The extracted transaction data and the indication of the transaction category may be provided to the customer by the financial institution system 240 through an online banking website (e.g., a mobile banking website) that the customer accesses via a web browser on the computing device 211 or through an online banking application on the computing device 211. In this regard, the online banking website and/or online banking application may present a graphical user interface (GUI) that displays information regarding one or more transactions associated with the customer's online banking account, including extracted transaction data (e.g., payee, memo data, and transaction amount) and an indication of the transaction category. In some embodiments, the transaction information (e.g., extracted transaction data and determined transaction category) may be presented as a list of the customer's most recent transactions. In other embodiments, the transaction information may be presented in a weekly, monthly, or annual statement.

In some embodiments, the financial institution system 240 may be configured so that the customer can change the category associated with a particular transaction.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A computing system for categorizing a transaction performed using a negotiable instrument associated with a customer's account, comprising:
a computer apparatus including a processor and a memory; and
a categorization module stored in the memory, executable by the processor and configured for:
receiving an indication of the transaction performed using the negotiable instrument, wherein receiving the indication of the transaction comprises receiving an image of the negotiable instrument;
extracting transaction data from the image of the negotiable instrument, wherein extracting transaction data comprises extracting memo data from the image of the negotiable instrument;
based at least in part on the extracted memo data, determining if the transaction is associated with a first predefined transaction category; and
presenting at least a portion of the transaction data extracted from the image of the negotiable instrument to the customer, wherein, if the transaction is associated with the first predefined transaction category, presenting at least a portion of the transaction data extracted from the image of the negotiable instrument to the customer comprises presenting an indication that the first predefined transaction category is associated with the transaction.

2. The computing system according to claim 1, wherein, if the transaction is not associated with any predefined transaction category, the categorization module is configured for:
presenting the extracted memo data and an indication that that the transaction could not be categorized to the customer; and
receiving an indication from the customer that the transaction is associated with the first predefined transaction category.

3. The computing system according to claim 2, wherein presenting the extracted memo data to the customer comprises presenting at least a portion of the image of the negotiable instrument to the customer, the portion of the image of the negotiable instrument being associated with the extracted memo data.

4. The computing system according to claim 1, wherein the categorization module is configured for determining that the transaction is associated with the first predefined transaction category and with a second predefined transaction category.

5. The computing system according to claim 4, wherein:
extracting transaction data comprises extracting a transaction amount from the image of the negotiable instrument;
determining that the transaction is associated with the first predefined transaction category and with the second predefined transaction category comprises determining that a first portion of the transaction amount is associated with the first predefined transaction category and that a second portion of the transaction amount is associated with the second predefined transaction category; and
presenting at least a portion of the transaction data extracted from the image of the negotiable instrument to the customer comprises presenting an indication that the first portion of the transaction amount is associated with the first predefined transaction category and that the second portion of the transaction amount is associated with the second predefined transaction category.

6. The computing system according to claim 1, wherein:
extracting transaction data comprises extracting payee information from the image of the negotiable instrument; and
determining if the transaction is associated with the first predefined transaction category is based at least in part on the payee information extracted from the image of the negotiable instrument.

7. The computing system according to claim 1, wherein the predefined transaction category is predefined by the customer.

8. A computer program product for categorizing a transaction performed using a negotiable instrument associated with a customer's account, comprising a non-transitory computer-readable storage medium having computer-executable instructions for:
receiving an indication of the transaction performed using the negotiable instrument, wherein receiving the indication of the transaction comprises receiving an image of the negotiable instrument;
extracting transaction data from the image of the negotiable instrument, wherein extracting transaction data comprises extracting memo data from the image of the negotiable instrument;
based at least in part on the extracted memo data, determining if the transaction is associated with a first predefined transaction category; and
presenting at least a portion of the transaction data extracted from the image of the negotiable instrument to the customer, wherein, if the transaction is associated with the first predefined transaction category, presenting at least a portion of the transaction data extracted from the image of the negotiable instrument to the customer comprises presenting an indication that the first predefined transaction category is associated with the transaction.

9. The computer program product according to claim 8, wherein, if the transaction is not associated with any predefined transaction category, the non-transitory computer-readable storage medium has computer-executable instructions for:
presenting the extracted memo data and an indication that that the transaction could not be categorized to the customer; and
receiving an indication from the customer that the transaction is associated with the first predefined transaction category.

10. The computer program product according to claim 9, wherein presenting the extracted memo data to the customer comprises presenting at least a portion of the image of the negotiable instrument to the customer, the portion of the image of the negotiable instrument being associated with the extracted memo data.

11. The computer program product according to claim 8, wherein the non-transitory computer-readable storage medium has computer-executable instructions for determining that the transaction is associated with the first predefined transaction category and with a second predefined transaction category.

12. The computer program product according to claim 11, wherein:
extracting transaction data comprises extracting a transaction amount from the image of the negotiable instrument;
determining that the transaction is associated with the first predefined transaction category and with the second predefined transaction category comprises determining that a first portion of the transaction amount is associated with the first predefined transaction category and that a second portion of the transaction amount is associated with the second predefined transaction category; and
presenting at least a portion of the transaction data extracted from the image of the negotiable instrument to the customer comprises presenting an indication that the first portion of the transaction amount is associated with the first predefined transaction category and that the second portion of the transaction amount is associated with the second predefined transaction category.

13. The computer program product according to claim 8, wherein:
extracting transaction data comprises extracting payee information from the image of the negotiable instrument; and
determining if the transaction is associated with the first predefined transaction category is based at least in part on the payee information extracted from the image of the negotiable instrument.

14. The computer program product according to claim 8, wherein the predefined transaction category is predefined by the customer.

15. A method for categorizing a transaction performed using a negotiable instrument associated with a customer's account, comprising:
receiving, with a processor, an indication of the transaction performed using the negotiable instrument, wherein receiving the indication of the transaction comprises receiving an image of the negotiable instrument;
extracting, with a processor, transaction data from the image of the negotiable instrument, wherein extracting transaction data comprises extracting memo data from the image of the negotiable instrument;
based at least in part on the extracted memo data, determining, with a processor, if the transaction is associated with a first predefined transaction category; and
presenting, with a processor, at least a portion of the transaction data extracted from the image of the negotiable instrument to the customer, wherein, if the transaction is associated with the first predefined transaction category, presenting at least a portion of the transaction data extracted from the image of the negotiable instrument to the customer comprises presenting an indication that the first predefined transaction category is associated with the transaction.

16. The method according to claim 15, comprising:
presenting the extracted memo data and an indication that that the transaction could not be categorized to the customer; and
receiving an indication from the customer that the transaction is associated with the first predefined transaction category.

17. The method according to claim 16, wherein presenting the extracted memo data to the customer comprises presenting at least a portion of the image of the negotiable instrument to the customer, the portion of the image of the negotiable instrument being associated with the extracted memo data.

18. The method according to claim 15, comprising determining that the transaction is associated with the first predefined transaction category and with a second predefined transaction category.

19. The method according to claim 18, wherein:
extracting transaction data comprises extracting a transaction amount from the image of the negotiable instrument;
determining that the transaction is associated with the first predefined transaction category and with the second predefined transaction category comprises determining that a first portion of the transaction amount is associated with the first predefined transaction category and that a second portion of the transaction amount is associated with the second predefined transaction category; and
presenting at least a portion of the transaction data extracted from the image of the negotiable instrument to the customer comprises presenting an indication that the first portion of the transaction amount is associated with the first predefined transaction category and that the second portion of the transaction amount is associated with the second predefined transaction category.

20. The method according to claim 15, wherein:
extracting transaction data comprises extracting payee information from the image of the negotiable instrument; and
determining if the transaction is associated with the first predefined transaction category is based at least in part on the payee information extracted from the image of the negotiable instrument.

21. The method according to claim 15, wherein the predefined transaction category is predefined by the customer.
